(19) United States
(12) Patent Application Publication
(10) Pub. No.: US 2019/0153961 A1
(43) Pub. Date: May 23, 2019

(54) GAS TURBINE SYSTEM

(71) Applicant: Panasonic Intellectual Property Management Co., Ltd., Osaka (JP)

(72) Inventors: MASAYA HONMA, Hyogo (JP); HIDETOSHI TAGUCHI, Osaka (JP)

(21) Appl. No.: 16/168,069

(22) Filed: Oct. 23, 2018

(30) Foreign Application Priority Data
Nov. 21, 2017 (JP) 2017-223283
May 22, 2018 (JP) 2018-097726

(51) Int. Cl. F02C 9/18; F02C 1/02; F02C 3/04; F02C 7/141

(52) U.S. Cl. CPC F02C 9/18; F02C 1/02; F05D 2270/303; F02C 7/141; F05D 2220/32; F02C 3/04

(57) ABSTRACT

A flow distributor changes a ratio between a flow rate of a working fluid flowing from an inlet to a first outlet and a flow rate of the working fluid flowing from the inlet to a second outlet. Into the inlet, the working fluid that is boosted by a first compressor and that is extracted from a gas turbine apparatus flows. A second compressor compresses the working fluid flowing from the first outlet. A first cooler cools the working fluid discharged from the second compressor. The first cooler cools the working fluid flowing from the second outlet to bypass the second compressor. A second expansion turbine expands the working fluid flowing from the first cooler.

### BACKGROUND

### 1. Technical Field

The present disclosure relates to a gas turbine system using a gas turbine apparatus.

### 2. Description of the Related Art

Conventionally, a gas turbine system using a gas turbine apparatus has been known. In an example of such a system, a compressor of a gas turbine apparatus generates a high-pressure working fluid. A part of the high-pressure working fluid thus generated is extracted. The part of the working fluid is recompressed and then expanded. In this example, in this way, cold heat is generated. The working fluid is air, for example. An example of such a system is disclosed in International Publication No. WO 2011/152049.

FIG. 3 illustrates a schematic configuration diagram of a gas turbine system 301A disclosed in International Publication No. WO 2011/152049. The gas turbine system 301A includes a gas turbine apparatus 302 and a cooling fluid generating apparatus 305.

The gas turbine apparatus 302 includes a first compressor 321, a first expansion turbine 323, and a combustor 326.

The cooling fluid generating apparatus 305 includes a second compressor 351, a cooler 355, and a second expansion turbine 353. A working fluid compressed by the first compressor 321 is extracted from the gas turbine apparatus 302 into the cooling fluid generating apparatus 305. The second compressor 351 compresses the extracted working fluid. Next, the cooler 355 cools the working fluid with a coolant. Next, the second expansion turbine 353 expands the working fluid flowing from the cooler 355. With the expansion, the temperature of the working fluid is further decreased. This enables to generate cold heat.

### SUMMARY

With respect to the technique disclosed in International Publication No. WO 2011/152049, there is room for further improvement in view of suppressing unnecessary energy consumption in the gas turbine system. One non-limiting and exemplary embodiment provides a gas turbine system that is able to generate necessary cold heat while suppressing unnecessary energy consumption.

In one general aspect, the techniques disclosed here feature a gas turbine system including a gas turbine apparatus and a cooling fluid generating apparatus. The gas turbine apparatus includes: a first compressor for compressing a working fluid; a combustor in which a fuel is injected into the working fluid discharged from the first compressor and combusted to generate a combustion gas; and a first expansion turbine for expanding the combustion gas generated in the combustor. The cooling fluid generating apparatus includes: a flow distributor including an inlet, a first outlet, and a second outlet, the flow distributor being configured to change a ratio between a flow rate of the working fluid flowing from the inlet to the first outlet and a flow rate of the working fluid flowing from the inlet to the second outlet, the working fluid that is boosted by the first compressor and is extracted from the gas turbine apparatus flowing into the inlet; a second compressor for compressing the working fluid flowing from the first outlet; a first cooler for cooling the working fluid discharged from the second compressor and for cooling the working fluid flowing from the second outlet to bypass the second compressor; and a second expansion turbine for expanding the working fluid flowing from the first cooler.

A gas turbine system according to the present disclosure is able to generate necessary cold heat while suppressing unnecessary energy consumption.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic configuration diagram of a gas turbine system in a first embodiment;

FIG. 2A is an explanatory diagram of an example of a flow distributor;

FIG. 2B is an explanatory diagram of another example of the flow distributor; and

FIG. 3 is a schematic configuration diagram of a gas turbine system according to a conventional technology.

### DETAILED DESCRIPTION

### (Underlying Knowledge Forming Basis of the Present Disclosure)

In the gas turbine system 301A disclosed in International Publication No. WO 2011/152049, in a cooler 355, the temperature of a working fluid is decreased. Thereafter, in the gas turbine system 301A, the temperature of the working fluid is further decreased in the second expansion turbine 353. The decreasing width of the temperature of the working fluid in the second expansion turbine 353 is widened as a pressure rate in the second expansion turbine 353 is increased. This pressure rate is increased when the working fluid compressed by the first compressor 321 is recompressed in the second compressor 351. Thus, recompression in the second compressor 351 contributes to generation of cold heat in the cooling fluid generating apparatus 305. On the other hand, for this recompression, power is required.

According to the investigation by the inventors, in the gas turbine system 301A disclosed in International Publication No. WO 2011/152049, even when the pressure rate in the second expansion turbine 353 is not high, there are some cases where necessary cold heat can be generated. This means that there are some cases where power that is not originally necessary is consumed by the recompression in the second compressor 351.

In view of the foregoing, the present disclosure aims to provide a gas turbine system that is able to generate necessary cold heat while suppressing unnecessary energy consumption.

### (Summary of an Aspect According to the Present Disclosure)

A gas turbine system according to a first aspect of the present disclosure includes a gas turbine apparatus and a cooling fluid generating apparatus. The gas turbine apparatus includes a first compressor for compressing a working fluid, a combustor in which a fuel is injected into the working fluid discharged from the first compressor and combusted to generate a combustion gas, and a first expansion turbine for expanding the combustion gas generated in the combustor. The cooling fluid generating apparatus includes a flow distributor. The flow distributor includes an inlet, a first outlet, and a second outlet, and the flow distributor is configured to change a ratio between a flow rate of the working fluid flowing from the inlet to the first outlet and a flow rate of the working fluid flowing from the inlet to the second outlet. The working fluid that is boosted by the first compressor and is extracted from the gas turbine apparatus flow into the inlet. The a cooling fluid generating apparatus further includes a second compressor for compressing the working fluid flowing from the first outlet, a first cooler for cooling the working fluid discharged from the second compressor and for cooling the working fluid flowing from the second outlet to bypass the second compressor, and a second expansion turbine for expanding the working fluid flowing from the first cooler.

The gas turbine system according to the first aspect is able to generate necessary cold heat while suppressing unnecessary energy consumption.

In a second aspect of the present disclosure, for example, in the gas turbine system according to the first aspect, the cooling fluid generating apparatus includes a second generator and a shaft. The shaft couples the second compressor, the second expansion turbine, and the second generator.

According to the second aspect, unnecessary power consumption is suppressed in the second compressor, enabling to increase the amount of power generated by the second generator.

In a third aspect of the present disclosure, for example, the gas turbine system according to the first or the second aspect, the cooling fluid generating apparatus includes a shaft, a bypass flow path, a suction flow path, a discharge flow path, a first branched flow path, and a second branched flow path. The shaft couples the second compressor and the second expansion turbine. In the bypass flow path, the working fluid flows from the second outlet, bypassing the second compressor, to the first cooler. The suction flow path connects the first outlet and a suction part of the second compressor. The discharge flow path connects a discharge part of the second compressor and a downstream end of the bypass flow path. The first branched flow path is connected to the suction flow path. The second branched flow path is connected to the discharge flow path.

According to the first branched flow path and the second branched flow path in the third aspect, stability in the operation of the second compressor and the cycle of the system can be secured.

In a fourth aspect of the present disclosure, for example, in the gas turbine system according to the third aspect, the cooling fluid generating apparatus includes a first valve and a second valve. The first valve is provided in the first branched flow path and the second valve is provided in the second branched flow path.

The first valve and the second valve in the fourth aspect are useful for appropriately causing the working fluid to flow to the second compressor.

In a fifth aspect of the present disclosure, for example, in the gas turbine system according to any one of the first to the fourth aspect, the cooling fluid generating apparatus includes a bypass flow path, a discharge flow path, and a third valve. In the bypass flow path, the working fluid flows from the second outlet, bypassing the second compressor, to the first cooler. The discharge flow path connects a discharge part of the second compressor and a downstream end of the bypass flow path. The third valve is provided in the discharge flow path.

The third valve in the fifth aspect is useful for appropriately causing the working fluid to flow in the discharge flow path.

In a sixth aspect of the present disclosure, for example, in the gas turbine system according to the fifth aspect, the third valve is a check valve. The check valve allows the working fluid to flow from the discharge part of the second compressor to the downstream end of the bypass flow path, and prohibits the working fluid from flowing from the downstream end of the bypass flow path to the discharge part of the second compressor.

The check valve in the sixth aspect is a specific example of the third valve.

In a seventh aspect of the present disclosure, for example, in the gas turbine system according to the fifth or the sixth aspect, the cooling fluid generating apparatus includes a second branched flow path. The second branched flow path is connected to the discharge flow path. The third valve is provided between a second branched part and the downstream end of the bypass flow path, where the second branched part is a connection part between the second branched flow path and the discharge flow path.

According to the seventh aspect, the working fluid can be prevented from flowing from the bypass flow path to the second branched flow path. Furthermore, even when a pressure obtained by the compression in the second compressor is lower than a pressure of the working fluid in the bypass flow path, the working fluid can flow from the second compressor to the second branched flow path.

In an eighth aspect of the present disclosure, for example, in the gas turbine system according to any one of the first to the seventh aspect, the cooling fluid generating apparatus includes a suction flow path. The suction flow path connects the first outlet and a suction part of the second compressor. The suction flow path includes a chamber.

With the chamber in the eighth aspect, transient shortage of the amount of the working fluid supplied to the second compressor is unlikely generated.

In a ninth aspect of the present disclosure, for example, the gas turbine system according to any one of the first to the eighth aspect includes a control apparatus. The first cooler is a heat exchanger that cools the working fluid by heat exchange between the working fluid and a coolant. The cooling fluid generating apparatus includes a temperature sensor that detects a temperature of the working fluid after the heat exchange with the coolant in the heat exchanger or a temperature of the coolant before the heat exchange with the working fluid in the heat exchanger. The control apparatus changes the rate by controlling the flow distributor in accordance with the temperature detected by the temperature sensor.

According to the ninth aspect, the ratio between a flow rate of the working fluid flowing from the inlet of the flow distributor to the first outlet and a flow rate of the working fluid flowing from the inlet to the second outlet can be changed at an appropriate timing.

In a tenth aspect of the present disclosure, for example, the gas turbine system according to any one of the first to the ninth aspect includes a first flow path, a second flow path, and a third flow path for the working fluid to flow. In the first flow path, the first compressor and the combustor are present in this order. In the second flow path, the first compressor, the inlet, the first outlet, the second compressor, the first cooler, and the second expansion turbine are present in this order. In the third flow path, the first compressor, the inlet, the second outlet, the first cooler, and the second expansion turbine are present in this order. The third flow path bypasses the second compressor.

The tenth aspect stipulates arrangement of each component in the gas turbine system structurally.

In the description below, embodiment of the present disclosure will be described with reference to the drawings. It is to be noted that the present disclosure is not limited by this embodiment.

Ordinal numbers such as the first, the second, and the third may herein be used. When a component is denoted with an ordinal number, there are not necessarily any component of the same kind that is denoted with a younger number. For example, when the term “the fourth flow path” is used, it does not necessarily mean that the first flow path, the second flow path, and the third flow path are present as well as the fourth flow path.

The expression “a pressure rate in an expansion turbine” may herein be used. Unless there is anything repugnant, “a pressure rate in an expansion turbine” represents a rate of the pressure of the working fluid at the inlet of the expansion turbine to the pressure of the working fluid at the outlet of the expansion turbine.

### First Embodiment

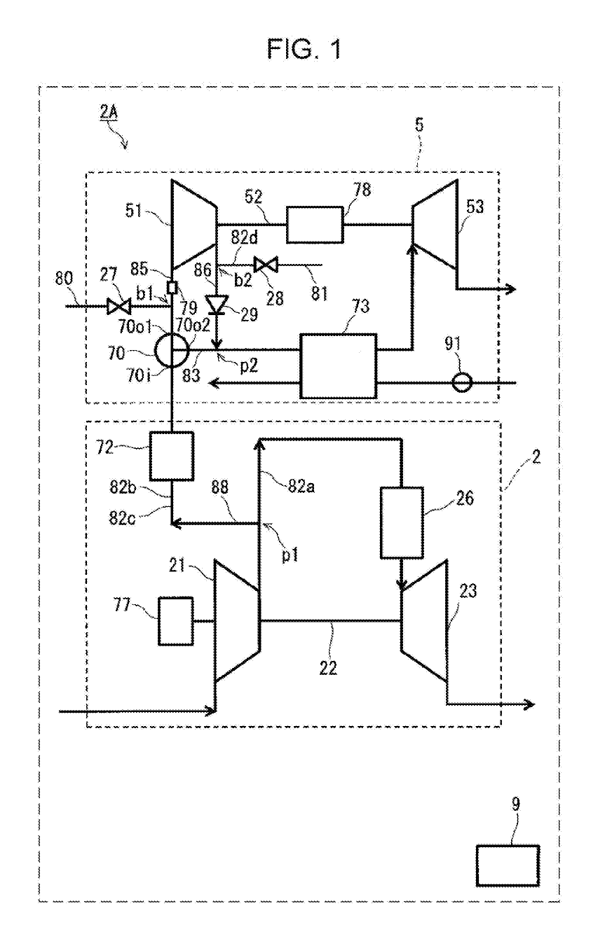

FIG. 1 is a schematic configuration diagram of a gas turbine system in a first embodiment.

In FIG. 1, a gas turbine system 2A includes a gas turbine apparatus 2, a cooling fluid generating apparatus 5, and a control apparatus 9. The gas turbine system 2A includes an extraction flow path 88. The extraction flow path 88 connects the gas turbine apparatus 2 and the cooling fluid generating apparatus 5.

In the present embodiment, as a working fluid for the gas turbine apparatus 2 and the cooling fluid generating apparatus 5, air is used.

Waste heat of the gas turbine apparatus 2 can be used as hot heat. On the other hand, in the cooling fluid generating apparatus 5, the working fluid is cooled to generate cold heat. For example, the cold heat can be used to form a cold atmosphere. When an object is placed in the cold atmosphere, the object can be cooled. For a specific example, the cooled working fluid itself forms a cold atmosphere. In this way, no medium of a different kind from the working fluid has to be used. Furthermore, when the cold atmosphere is used for a refrigerated storage or the like, frost generation can be easily suppressed. However, the cold heat of the cooled working fluid may be given to a medium of a different kind from the working fluid by heat exchange so as to form a cold atmosphere using the medium thus cooled. Furthermore, the cold atmosphere can be used for use other than freezing, such as cold storage or air conditioning.

The gas turbine apparatus 2 includes a first compressor 21, a first shaft 22, a first expansion turbine 23, a combustor 26, a second cooler 72, a first generator 77, the extraction flow path 88, and a first connection point p1.

The cooling fluid generating apparatus 5 includes a second compressor 51, a second shaft 52, a second expansion turbine 53, a first cooler 73, a second generator 78, a flow distributor 70, a suction flow path 85, a discharge flow path 86, a bypass flow path 83, a first branched flow path 80, a second branched flow path 81, a first valve 27, a second valve 28, a third valve 29, and a temperature sensor 91. A second connection point p2 in FIG. 1 corresponds to the downstream end of the bypass flow path 83 and the downstream end of the discharge flow path 86. In the description below, these downstream ends may be referred to as downstream ends p2.

In the gas turbine system 2A, a first flow path 82a, a second flow path 82b, a third flow path 82c, and a fourth flow path 82d for the working fluid to flow are formed. In other words, the gas turbine system 2A includes the first flow path 82a, the second flow path 82b, the third flow path 82c, and the fourth flow path 82d for the working fluid to flow.

In the first flow path 82a, the first compressor 21 and the combustor 26 are present in this order. Specifically, in the first flow path 82a, the first compressor 21, the first connection point p1, and the combustor 26 are present in this order.

In the second flow path 82b, the first compressor 21, an inlet 70i of the flow distributor 70, a first outlet 70o1 of the flow distributor 70, the second compressor 51, the first cooler 73, and the second expansion turbine 53 are present in this order. Specifically, in the second flow path 82b, the first compressor 21, the first connection point p1, the extraction flow path 88, the inlet 70i, the first outlet 70o1, the suction flow path 85, the second compressor 51, the discharge flow path 86, the first cooler 73, and the second expansion turbine 53 are present in this order.

In the third flow path 82c, the first compressor 21, the inlet 70i of the flow distributor 70, a second outlet 70o2 of the flow distributor 70, the first cooler 73, and the second expansion turbine 53 are present in this order. Specifically, in the third flow path 82c, the first compressor 21, the first connection point p1, the extraction flow path 88, the inlet 70i, the second outlet 70o2, the bypass flow path 83, the first cooler 73, and the second expansion turbine 53 are present in this order.

The third flow path 82c bypasses the second compressor 51. Specifically, between the flow distributor 70 and the first cooler 73, the second compressor 51 and the bypass flow path 83 are provided in parallel.

In the fourth flow path 82d, the first branched flow path 80, the second compressor 51, and the second branched flow path 81 are present in this order.

The fourth flow path 82d is another flow path different from the second flow path 82b for causing the working fluid to flow to the second compressor 51. Specifically, the working fluid that has not run through the flow distributor 70 flows in the first branched flow path 80, the second compressor 51, and the second branched flow path 81 in this order. The second branched flow path 81 collects the working fluid discharged from the second compressor 51 before the working fluid reaches the third flow path 82c.

In the description below, each component in the gas turbine system 2A according to the present embodiment will be described.

The first compressor 21 compresses the working fluid. In the present embodiment, the first compressor 21 is a turbo compressor such as a centrifugal compressor.

The combustor 26 combusts the working fluid discharged from the first compressor 21 by injecting fuel into the working fluid.

As the fuel combusted by the combustor 26, liquid fuel and gaseous fuel are exemplified. As the liquid fuel, liquefied natural gas (LNG), gasoline, diesel oil, and alcohol fuel such as methanol and ethanol are exemplified. The liquid fuel may be an alcohol-blended fuel containing alcohol fuel. As the gaseous fuel, city gas, compressed natural gas (CNG), liquefied petroleum gas (LPG), and hydrogen are exemplified.

When the liquid fuel is used, an advantage is obtained in that the volume of a fuel tank which is not illustrated can be downsized. When the gaseous fuel is used, an advantage is obtained in that a fuel injection mechanism or the like into the combustor 26 can be simplified.

The first expansion turbine 23 expands the combustion gas generated in the combustor 26.

The first shaft 22 couples the first compressor 21 and the first expansion turbine 23. Specifically, the first shaft 22 couples the first compressor 21, the first expansion turbine 23, and the first generator 77.

In the present embodiment, the first generator 77 operates as a generator as well as an electric motor. For example, the first generator 77 is used as an electric motor at the time of activation of the first compressor 21. Specifically, the first generator 77 can drive the first compressor 21 by rotating the first shaft 22.

The extraction flow path 88 connects the first connection point p1 and the flow distributor 70. In the extraction flow path 88, the working fluid that is boosted by the first compressor 21 and that is extracted from the gas turbine apparatus 2 flows.

The second cooler 72 cools the working fluid that is boosted by the first compressor 21 and that is extracted from the gas turbine apparatus 2 before the working fluid flows into the inlet 70i. In the present embodiment, the second cooler 72 is provided to the extraction flow path 88. The second cooler 72 cools the working fluid in the extraction flow path 88. Specifically, the second cooler 72 is a heat exchanger. In the second cooler 72, the working fluid is cooled by heat exchange with a coolant. As the coolant, outside air, cold air, cooling water, the fuel flowing into the combustor 26, and the like can be cited.

The flow distributor 70 includes the inlet 70i, the first outlet 70o1, and the second outlet 70o2. In the description below, the flow rate of the working fluid flowing from the inlet 70i to the first outlet 70o1 is referred to as a first flow rate in some cases. The flow rate of the working fluid flowing from the inlet 70i to the second outlet 70o2 is referred to as a second flow rate in some cases. The flow distributor 70 is configured so as to allow the ratio between the first flow rate and the second flow rate to be changed.

Into the inlet 70i, the working fluid that is boosted by the first compressor 21 and that is extracted from the gas turbine apparatus 2 flows. The inlet 70i is connected to the extraction flow path 88.

The first outlet 70o1 is connected to the suction flow path 85. The second outlet 70o2 is connected to the bypass flow path 83. Specifically, the second outlet 70o2 is connected to the upstream end of the bypass flow path 83.

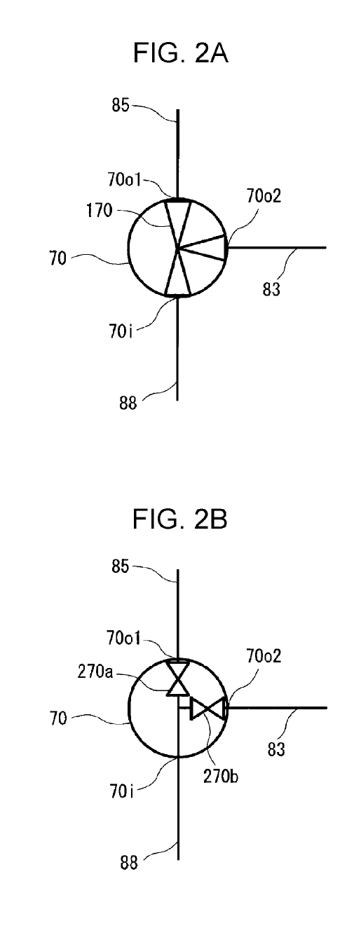

FIG. 2A illustrates an example of the flow distributor 70. In the example in FIG. 2A, the flow distributor 70 includes a valve 170. In the example in FIG. 2A, the flow distributor 70 is configured so as to allow the ratio between the first flow rate and the second flow rate to be changed using one valve 170. When the flow distributor 70 is formed using one valve 170 as in FIG. 2A, an advantage is obtained in that the number of components can be reduced.

FIG. 2B illustrates another example of the flow distributor 70. In the example in FIG. 2B, the flow distributor 70 includes valves 270a and 270b. In the example in FIG. 2B, the flow distributor 70 is configured so as to allow the ratio between the first flow rate and the second flow rate to be changed using two valves, 270a and 270b. The valve 270a is connected to the suction flow path 85. The outflow port of the valve 270a corresponds to the first outlet 70o1. The valve 270b is connected to the bypass flow path 83. The outflow port of the valve 270b corresponds to the second outlet 70o2.

The second compressor 51 compresses the working fluid flowing from the first outlet 70o1. In the present embodiment, the second compressor 51 is a turbo compressor such as a centrifugal compressor.

The suction part of the second compressor 51 is connected to the suction flow path 85. Specifically, the suction part of the second compressor 51 is connected to the downstream end of the suction flow path 85. The upstream end of the suction flow path 85 is connected to the first outlet 70o1. That is to say, the suction flow path 85 connects the first outlet 70o1 and the suction part of the second compressor 51.

The discharge part of the second compressor 51 is connected to the discharge flow path 86. Specifically, the discharge part of the second compressor 51 is connected to the upstream end of the discharge flow path 86. The downstream end p2 of the discharge flow path 86 is connected to the downstream end p2 of the bypass flow path 83. That is to say, the discharge flow path 86 connects the discharge part of the second compressor 51 and the downstream end p2 of the bypass flow path 83.

The first cooler 73 cools the working fluid discharged from the second compressor 51. Specifically, the first cooler 73 cools the working fluid flowing from the discharge flow path 86.

Furthermore, the first cooler 73 cools the working fluid flowing from the second outlet 70o2 to bypass the second compressor 51. Specifically, in the bypass flow path 83, the working fluid flows from the second outlet 70o2, bypassing the second compressor 51, to the first cooler 73. The first cooler 73 cools that working fluid flowing from the bypass flow path 83.

It is to be noted that the expression “the first cooler for cooling the working fluid discharged from the second compressor and for cooling the working fluid flowing from the second outlet to bypass the second compressor” is herein used in some cases. This expression should not be interpreted as indicating only an aspect in which the former working fluid and the latter working fluid are cooled by the first cooler at the same time. This expression is used to mean that a period during which the first cooler does not cool the former working fluid but cools the latter working fluid may be present, and a period during which the first cooler does not cool the latter working fluid but cools the former working fluid may be present.

The first cooler 73 is provided to a flow path that connects the second connection point p2 and the second expansion turbine 53.

In the present embodiment, the first cooler 73 is a heat exchanger. In the first cooler 73, the working fluid is cooled by heat exchange with a coolant. As the coolant, outside air, cold air, cooling water, the fuel flowing into the combustor 26, and the like can be cited.

The second expansion turbine 53 expands the working fluid flowing from the first cooler 73.

The second shaft 52 couples the second compressor 51 and the second expansion turbine 53. Specifically, the second shaft 52 couples the second compressor 51, the second expansion turbine 53, and the second generator 78.

In the present embodiment, the second generator 78 operates as a generator as well as an electric motor. For example, the second generator 78 is used as an electric motor at the time of activation of the second compressor 51. Specifically, the second generator 78 can drive the second compressor 51 by rotating the second shaft 52.

The second compressor 51 and the second expansion turbine 53 do not necessarily have to be coupled to each other by the second shaft 52. The second compressor 51 and the second expansion turbine 53 may be separated from each other. In one example of such a case, to the second compressor 51, an electric motor is connected. To the second expansion turbine 53, a generator is connected. The shaft of the second compressor 51 and the shaft of the second expansion turbine 53 are different ones. In this way, rotation of a rotor of the second compressor 51 can be stopped independently of the second expansion turbine 53. Specifically, even when a rotor of the second expansion turbine 53 is rotated, in conjunction with this rotation, the rotor of the second compressor 51 does not have to be rotated. With this, for maintaining rotation of the rotor of the second compressor 51, the first branched flow path 80 and the second branched flow path 81 do not have to be provided. Furthermore, waste of energy due to idle rotation of the rotor of the second compressor 51 can be avoided.

Similarly, the first compressor 21 and the first expansion turbine 23 may be separated from each other. For example of such a case, to the first compressor 21, an electric motor is connected. To the first expansion turbine 23, a generator is connected. The shaft of the first compressor 21 and the shaft of the first expansion turbine 23 are different ones.

The third valve 29 is provided to the discharge flow path 86. The third valve 29 is useful for appropriately causing the working fluid to flow in the discharge flow path 86.

Specifically, the third valve 29 allows the working fluid to flow from the discharge part of the second compressor 51 to the second connection point p2, and prohibits the working fluid from flowing from the second connection point p2 to the discharge part of the second compressor 51. This enables to prevent the working fluid from running through the bypass flow path 83 and the discharge flow path 86 to flow into the discharge part of the second compressor 51.

The third valve 29 is useful also in some cases for avoiding a situation in which the working fluid cannot be discharged from the discharge part of the second compressor 51. Specifically, in the gas turbine system 2A, it is possible to supply the working fluid to the second compressor 51 via the first branched flow path 80 while causing all working fluids that have flowed into the inlet 70i of the flow distributor 70 to flow from the second outlet 70o2. In this case, although it depends on the operation conditions of the gas turbine system 2A, a pressure obtained by the compression by the second compressor 51 can be lower than a pressure of the working fluid in the second outlet 70o2 and in the bypass flow path 83. In this case, if the third valve 29 is not present in the discharge flow path 86, there is a risk of causing a situation in which the working fluid cannot be discharged from the second compressor 51. Furthermore, there is a risk of causing a failure of the second compressor 51 or the like due to hindrance of the rotation of the rotor of the second compressor 51 despite rotation force of the second expansion turbine 53 being transmitted to the second compressor 51. However, according to the third valve 29, such a situation can be avoided.

In the present embodiment, the third valve 29 is a check valve. This check valve is provided so as to allow the working fluid to flow from the discharge part of the second compressor 51 to the second connection point p2 and prohibit the working fluid from flowing from the second connection point p2 to the discharge part of the second compressor 51.

The third valve 29 may be a gate valve, and may be a flow control valve. In such cases also, the opening and closing timing of the valve is controlled by the control apparatus 9, whereby the same effects can be obtained as in a case where the third valve 29 is a check valve.

The third valve 29 is provided between the second branched part b2 and the downstream end p2 of the bypass flow path 83, for example, where the second branched part b2 is the connection part between the second branched flow path 81 and the discharge flow path 86. With this, the working fluid can be prevented from flowing from the bypass flow path 83 to the second branched flow path 81. Furthermore, even when a pressure obtained by the compression in the second compressor 51 is lower than a pressure of the working fluid in the bypass flow path 83, the working fluid can flow from the second compressor 51 to the second branched flow path 81.

In the present embodiment, the control apparatus 9 controls the flow distributor 70, the first valve 27, the second valve 28, and the like. The control apparatus 9 can control the flow distributor 70, the first valve 27, and the second valve 28 based on the temperature detected by the temperature sensor 91. As one specific example, from the temperature sensor 91 to the control apparatus 9, a detection signal presenting a detected temperature is transmitted. The control apparatus 9 determines the ratio between the first flow rate and the second flow rate in the flow distributor 70 and the opening degree or the opening and closing state of the first valve 27 and the second valve 28 based on the detection signal. The control apparatus 9 transmits a control signal to the flow distributor 70, thereby controlling the above-described rate. The control apparatus 9 transmits a control signal to each of the first valve 27 and the second valve 28, thereby controlling the opening degree or the opening and closing state of the first valve 27 and the second valve 28. When the third valve 29 is a flow control valve or an opening and closing valve, the control apparatus 9 may control the third valve 29. Specifically, the control apparatus 9 may transmit a control signal to the third valve 29, thereby controlling the opening degree or the opening and closing state of the third valve 29.

In the description below, operations and actions of the gas turbine system 2A will be described.

In the present embodiment, air in the atmosphere flows into the gas turbine apparatus 2 as a working fluid. The first compressor 21 suctions this working fluid and compresses the suctioned working fluid.

A part of the working fluid compressed by the first compressor 21 flows into the combustor 26. In the combustor 26, fuel is injected into the flowing working fluid and the fuel is combusted. With this, a high temperature combustion gas is generated.

The combustion gas flows into the first expansion turbine 23. In the first expansion turbine 23, the working fluid is expanded and the pressure thereof is decreased to the degree of the atmospheric pressure.

The first expansion turbine 23 extracts power as a rotation torque from the expanded combustion gas and drives the first compressor 21, and at the same time, gives surplus power to the first generator 77. Thus, in the first generator 77, power generation using an output from the first expansion turbine 23 is performed.

Waste heat of the first expansion turbine 23 can be used as hot heat. This hot heat can be used for heating, hot-water supply, and the like. Forming a generator using this hot heat also is possible.

A part of the working fluid discharged from the first compressor 21 flows to the combustor 26 via the first connection point p1, as described above. Another part of the working fluid discharged from the first compressor 21 is branched at the first connection point p1 to flow into the extraction flow path 88.

The working fluid flowing into the extraction flow path 88 from the first connection point p1 is cooled by the second cooler 72 and thereafter flows into the cooling fluid generating apparatus 5. The working fluid flowing into the cooling fluid generating apparatus 5 via the extraction flow path 88 may be referred to as extraction.

The working fluid flowing into the cooling fluid generating apparatus 5 flows into the inlet 70i of the flow distributor 70. The working fluid flowing into the inlet 70i flows from the first outlet 70o1 or the second outlet 70o2.

The working fluid flowing from the first outlet 70o1 is compressed by the second compressor 51. Thereafter, the working fluid flows into the first cooler 73 via the third valve 29.

The working fluid flowing from the second outlet 70o2 bypasses the second compressor 51 and the third valve 29 to flow into the first cooler 73.

In the first cooler 73, the working fluid is cooled.

The working fluid flowing from the first cooler 73 flows into the second expansion turbine 53. In the second expansion turbine 53, the working fluid is expanded and the pressure thereof is decreased to the degree of the atmospheric pressure. With this expansion, the temperature of the working fluid is further decreased. With this, the working fluid becomes a cooling fluid such as cold air. The temperature of the cooling fluid is 10° C. to −100° C., for example.

The second expansion turbine 53 extracts power as a rotation torque from the expanded working fluid and drives the second compressor 51, and at the same time, gives surplus power to the second generator 78. Thus, in the second generator 78, power generation using an output from the second expansion turbine 53 is performed.

(Advantage Obtained from Flow Distributor 70)

In the gas turbine system 2A, the temperature of the working fluid is decreased in the first cooler 73. Thereafter, in the gas turbine system 2A, the temperature of the working fluid is further decreased in the second expansion turbine 53. The decreasing width of the temperature of the working fluid in the second expansion turbine 53 is widened as a pressure rate in the second expansion turbine 53 is increased. This pressure rate is increased when the working fluid compressed by the first compressor 21 is recompressed in the second compressor 51. Thus, recompression in the second compressor 51 contributes to generation of cold heat in the cooling fluid generating apparatus 5. On the other hand, for this recompression, power is required.

In the gas turbine system 2A, even when the pressure rate in the second expansion turbine 53 is not high, there are some cases where necessary cold heat can be generated. In these cases, a case where a cooling load is low, for example, the temperature of an object to be cooled is close to a target temperature is included. A case where the temperature of the coolant supplied to the first cooler 73 is adequately low also is included. In these cases, when the contribution of the recompression to generation of cold heat is minimized, power consumption due to unnecessary recompression in the second compressor 51 can be suppressed.

In view of the foregoing, in the present embodiment, the flow distributor 70 is configured so as to allow the ratio between the first flow rate and the second flow rate to be changed. As described above, the first flow rate is the flow rate of the working fluid flowing from the inlet 70i to the first outlet 70o1. The second flow rate is the flow rate of the working fluid flowing from the inlet 70i to the second outlet 70o2. Causing a working fluid with a high flow rate to flow from the inlet 70i to the first outlet 70o1 is suitable for securing a high pressure rate in the second expansion turbine 53 due to the contribution of the recompression in the second compressor 51. Thus, according to the present embodiment, when a high pressure rate is required in view of generating necessary cold heat, the high pressure rate can be achieved. By contrast, causing a working fluid with a high flow rate to flow from the inlet 70i to the second outlet 70o2 is suitable for suppressing unnecessary power consumption in the second compressor 51 in a case where necessary cold heat can be generated even when the pressure rate in the second expansion turbine 53 is not high. For the above-described reasons, according to the gas turbine system 2A in the present embodiment, necessary cold heat can be generated while suppressing unnecessary energy consumption.

In the present embodiment, the flow distributor 70 is configured so as to allow the ratio between the first flow rate and the second flow rate to be set to an optional value between 0:100 to 100:0. In the example in FIG. 2A, a three-way flow control valve is employed as the valve 170 so as to be able to form such a flow distributor 70. In the example in FIG. 2B, a flow control valve is employed as the valves 270a and 270b so as to be able to form such a flow distributor 70. By enabling to optionally set the ratio between the first flow rate and the second flow rate, the flow rate of the working fluid flowing to the second compressor 51 can be adjusted so as to smoothly activate the second compressor 51. Furthermore, by performing fine adjustment of the flow rate of the working fluid flowing to the second compressor 51, fine adjustment of the temperature of the working fluid flowing from the second expansion turbine 53 becomes easy. In a case where the cold heat of the working fluid is used for a refrigerated storage, the temperature of the refrigerated storage slightly exceeds an appropriate temperature in some cases. However, with the fine adjustment of the flow rate as described above, cooling power is rapidly enhanced to prevent the temperature of the refrigerated storage from being excessively decreased. That is to say, it is possible to moderately enhance cooling power to return the above-described temperature to an appropriate temperature.

However, the flow distributor 70 may be a flow path switching device that sets this rate to either 0:100 or 100:0. In the example in FIG. 2A, a three-way valve is employed as the valve 170 so as to be able to form such a flow distributor 70. In the example in FIG. 2B, an opening and closing valve is employed as the valves 270a and 270b so as to be able to form such a flow distributor 70.

Causing a working fluid with a high flow rate to flow from the inlet 70i to the first outlet 70o1 enables the recompression in the second compressor 51 to greatly contribute to generation of cold heat. This is useful in a case where an object to be cooled has to be rapidly cooled, the cooling performance of the first cooler 73 is low, or the like.

By contrast, by causing a working fluid with a high flow rate to flow from the inlet 70i to the second outlet 70o2, unnecessary power consumption in the second compressor 51 can be suppressed. This is useful in a case where an object to be cooled does not have to be rapidly cooled, the cooling performance of the first cooler 73 is high, or the like.

After the object to be cooled is rapidly cooled and the temperature thereof is adequately decreased, the temperature of the object to be cooled may be maintained within an allowable range. In such a case, firstly, a working fluid with a high flow rate can flow from the inlet 70i to the first outlet 70o1, and then, a working fluid with a high flow rate can flow from the inlet 70i to the second outlet 70o2. By contrast, gradually increasing the flow rate of the working fluid flowing to the second compressor 51 can contribute to smoothly activating the second compressor 51. In view of such a smooth activation, firstly, a working fluid with a high flow rate can flow from the inlet 70i to the second outlet 70o2, and then, a working fluid with a high flow rate can flow from the inlet 70i to the first outlet 70o1.

In the present embodiment, the second shaft 52 couples the second compressor 51, the second expansion turbine 53, and the second generator 78. In this way, the rotation force obtained by the second expansion turbine 53 can be transmitted to the second compressor 51 and the second generator 78. With this configuration, when the power of the second compressor 51 is decreased, the amount of power generated by the second generator 78 is increased. With this, by suppressing unnecessary power consumption in the second compressor 51, the amount of power generated by the second generator 78 can be increased.

In the present embodiment, the first cooler 73 is a heat exchanger that cools the working fluid by heat exchange between the working fluid and a coolant.

In the example in FIG. 1, the temperature sensor 91 detects the temperature of the coolant before the heat exchange with the working fluid in the first cooler 73. Specifically, in the example in FIG. 1, the gas turbine system 2A includes a flow path of the coolant that passes through the first cooler 73. In the flow path, the temperature sensor 91 is provided in the upstream side from the first cooler 73. The control apparatus 9 changes the ratio between the first flow rate and the second flow rate by controlling the flow distributor 70 in accordance with the temperature detected by the temperature sensor 91. In this way, this rate can be changed at an appropriate timing.

An objected to be detected by the temperature sensor 91 may be the temperature of the working fluid. In a modification, the temperature sensor 91 detects the temperature of the working fluid after the heat exchange with the coolant in the first cooler 73. Specifically, the temperature sensor 91 detects the temperature of the working fluid flowing in the flow path connecting the first cooler 73 and the second expansion turbine 53, the temperature of the working fluid flowing in the second expansion turbine 53, or the temperature of the working fluid flowing from the second expansion turbine 53. This also enables to obtain the same effects.

The above-described rate may be manually changed.

In the present embodiment, control modes of the control apparatus 9 include a rate changing mode. In the rate changing mode, the ratio between the first flow rate and the second flow rate is once fixed to B:100−B while the rate is changed from A:100−A to C:100−C. At this point, 0≤C<B<A≤100 or 0≤A<B<C≤100 is satisfied. In this way, compared with a case where the rate is changed from A:100−A to C:100−C in one go, the cycle of the gas turbine system 2A is unlikely disturbed. In one specific example, the rate changing mode is started when the temperature detected by the temperature sensor 91 according to the example in FIG. 1 or the modification reaches a first threshold. The fixation of the rate to B:100−B is cancelled when the temperature detected by the temperature sensor 91 reaches a second threshold. In the case of 0≤C<B<A≤100, for example, C is equal to or higher than 0 and equal to or lower than 20, B is equal to or higher than 40 and equal to or lower than 60, and A is equal to or higher than 80 and equal to or lower than 100. In the case of 0≤A<B<C≤100, for example, A is equal to or higher than 0 and equal to or lower than 20, B is equal to or higher than 40 and equal to or lower than 60, and C is equal to or higher than 80 and equal to or lower than 100.

(Advantage Obtained from First Branched Flow Path 80 and Second Branched Flow Path 81)

In the present embodiment, the second shaft 52 couples the second compressor 51 and the second expansion turbine 53. The suction flow path 85 connects the first outlet 70o1 and the suction part of the second compressor 51. The discharge flow path 86 connects the discharge part of the second compressor 51 and the downstream end p2 of the bypass flow path 83. The first branched flow path 80 is connected to the suction flow path 85. The second branched flow path 81 is connected to the discharge flow path 86. In the present embodiment, the rotation force obtained by the second expansion turbine 53 can be used for the rotation of the rotor of the second compressor 51. Furthermore, in a case where the working fluid with a flow rate adequate for the rotation of the rotor cannot flow from the flow distributor 70 to the second compressor 51 due to a working fluid flowing in the bypass flow path 83, the first branched flow path 80 and the second branched flow path 81 can be used for the working fluid to flow to the second compressor 51. With this, stability in the operation of the second compressor 51 and the cycle of the system can be secured.

In the present embodiment, the first valve 27 is provided in the first branched flow path 80. The second valve 28 is provided in the second branched flow path 81. The first valve 27 and the second valve 28 are useful for appropriately causing the working fluid to flow to the second compressor 51.

In the present embodiment, the first valve 27 and the second valve 28 are flow control valves. However, the first valve 27 and the second valve 28 may be gate valves.

In the present embodiment, air in the atmosphere flows into the first branched flow path 80 as a working fluid. This working fluid is suctioned by the second compressor 51. The working fluid discharged from the second compressor 51 is released to the atmosphere via the second branched flow path 81.

With the first branched flow path 80 and the second branched flow path 81 provided, or instead of providing the first branched flow path 80 and the second branched flow path 81, a clutch may be provided to the second shaft 52. In such a case, unstable rotation of the second compressor 51 can be avoided by the clutch separating the second expansion turbine 53 and the second compressor 51.

When changing the ratio between the first flow rate and the second flow rate, the second generator 78 may be operated as an electric motor. This can contribute to stable rotation of the rotors of the second compressor 51 and the second expansion turbine 53.

The suction flow path 85 may include a chamber. The chamber can function as a static pressure reservoir. With the chamber, a situation in which transient shortage of the amount of the working fluid supplied to the second compressor 51 is unlikely generated. With the chamber, it is easy to avoid generation of surging in the second compressor 51 in a case where the first flow rate is restricted. When the connection part between the first branched flow path 80 and the suction flow path 85 is a first branched part b1, the chamber is provided between the first branched part b1 and the suction part of the second compressor 51, for example. With respect to a typical chamber, the cross section area of the space inside the chamber is larger than the cross section area of the opening part of the chamber.

A flow path for returning the working fluid from the second branched flow path 81 to the first branched flow path 80 may be provided. In this manner, the flow rate of the working fluid suctioned by the suction part of the second compressor 51 can be the same as or close to the flow rate of the working fluid discharged from the discharged part of the second compressor 51. This also can suppress generation of surging in the second compressor 51 due to shortage of the suctioned working fluid.

In the description below, an example of an adjusting method of the flow distributor 70, the first valve 27, and the second valve 28 in a case where the first flow rate is reduced and the second flow rate is increased will be described.

In one example, the above-described rate of the flow distributor 70 is changed such that a period X from the start to the end of the change of the rate includes a time point T. Increasing the opening degree of the first valve 27 is performed such that a period Y from the start to the end of increasing the opening degree includes the time point T. Increasing the opening degree of the second valve 28 is performed such that a period Z from the start to the end of increasing the opening degree includes the time point T. Causing these three periods X, Y, and Z to include the same time point T is suitable for preventing surging in the second compressor 51 and a stall of the second expansion turbine 53.

However, the periods X, Y, and Z do not necessarily have to include the same time point T. The above-described rate may be changed after the increasing of the opening degree of the first valve 27 and the increasing of the opening degree of the second valve 28 have been completed.

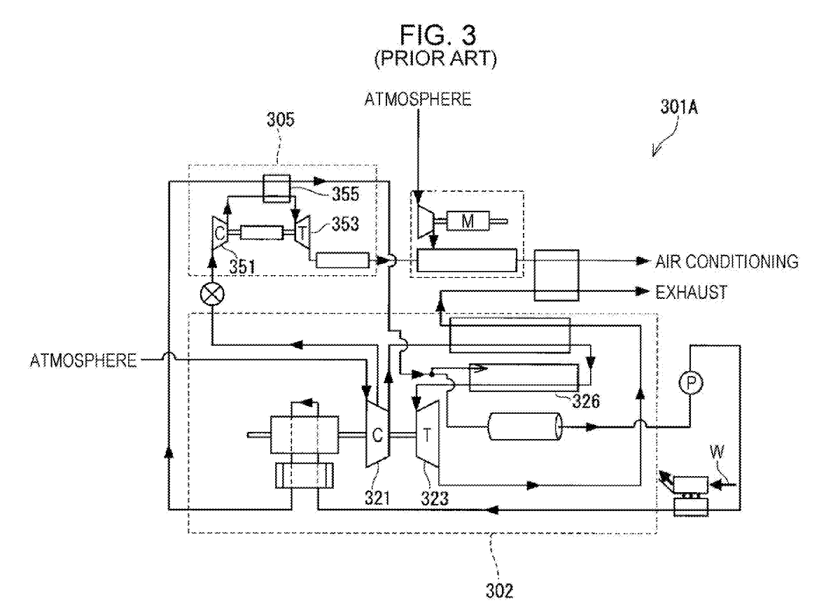

In FIG. 1, an aspect in which the working fluid after the compression by the first compressor 21 is completed is extracted, and the working fluid is used as extraction in the cooling fluid generating apparatus 5 is illustrated. However, following the technique in International Publication No. WO 2011/152049 and FIG. 3, an aspect can be employed in which air being compressed by the first compressor 21 is extracted from an intermediate pressure point in the first compressor 21 and the working fluid thereof is used as extraction in the cooling fluid generating apparatus 5. The expression “the working fluid that is boosted by the first compressor 21 and that is extracted from the gas turbine apparatus 2 flows into the inlet 70i” is an expression used to intend to cover both a case where the extraction in the former aspect flows into the inlet 70i and a case where the extraction in the latter aspect flows into the inlet 70i.

The gas turbine system according to the present disclosure can be suitably used in equipment using electricity, cold heat, and hot heat. This gas turbine system can be used in a grocery store, a food processing factory, a vehicle, the medical field, the biotechnological field, and the like.

What is claimed is:

1. A gas turbine system comprising:
a gas turbine apparatus including:
a first compressor for compressing a working fluid;
a combustor in which a fuel is injected into the working fluid discharged from the first compressor and combusted to generate a combustion gas; and
a first expansion turbine for expanding the combustion gas generated in the combustor; and
a cooling fluid generating apparatus including:
a flow distributor including an inlet, a first outlet, and a second outlet, the flow distributor being configured to change a ratio between a flow rate of the working fluid flowing from the inlet to the first outlet and a flow rate of the working fluid flowing from the inlet to the second outlet, the working fluid that is boosted by the first compressor and is extracted from the gas turbine apparatus flowing into the inlet;
a second compressor for compressing the working fluid flowing from the first outlet;
a first cooler for cooling the working fluid discharged from the second compressor and for cooling the working fluid flowing from the second outlet to bypass the second compressor; and
a second expansion turbine for expanding the working fluid flowing from the first cooler.

2. The gas turbine system according to claim 1, wherein:
the cooling fluid generating apparatus includes a second generator and a shaft, and
the shaft couples the second compressor, the second expansion turbine, and the second generator.

3. The gas turbine system according to claim 1, wherein:
the cooling fluid generating apparatus includes a shaft, a bypass flow path, a suction flow path, a discharge flow path, a first branched flow path, and a second branched flow path,
the shaft couples the second compressor and the second expansion turbine,
in the bypass flow path, the working fluid flows from the second outlet, bypassing the second compressor, to the first cooler,
the suction flow path connects the first outlet and a suction part of the second compressor,
the discharge flow path connects a discharge part of the second compressor and a downstream end of the bypass flow path,
the first branched flow path is connected to the suction flow path, and
the second branched flow path is connected to the discharge flow path.

4. The gas turbine system according to claim 3, wherein:
the cooling fluid generating apparatus includes a first valve and a second valve,
the first valve is provided in the first branched flow path, and
the second valve is provided in the second branched flow path.

5. The gas turbine system according to claim 1, wherein
the cooling fluid generating apparatus includes a bypass flow path, a discharge flow path, and a third valve,
in the bypass flow path, the working fluid flows from the second outlet, bypassing the second compressor, to the first cooler,
the discharge flow path connects a discharge part of the second compressor and a downstream end of the bypass flow path, and
the third valve is provided in the discharge flow path.

6. The gas turbine system according to claim 5, wherein:
the third valve is a check valve, and
the check valve allows the working fluid to flow from the discharge part of the second compressor to the downstream end of the bypass flow path, and prohibits the working fluid from flowing from the downstream end of the bypass flow path to the discharge part of the second compressor.

7. The gas turbine system according to claim 5, wherein:
the cooling fluid generating apparatus includes a second branched flow path,
the second branched flow path is connected to the discharge flow path, and
the third valve is provided between a second branched part and the downstream end of the bypass flow path, where the second branched part is a connection part between the second branched flow path and the discharge flow path.

8. The gas turbine system according to claim 1, wherein:
the cooling fluid generating apparatus includes a suction flow path,
the suction flow path connects the first outlet and a suction part of the second compressor, and
the suction flow path includes a chamber.

9. The gas turbine system according to claim 1, further comprising:
a control apparatus, wherein:
the first cooler is a heat exchanger that cools the working fluid by heat exchange between the working fluid and a coolant,
the cooling fluid generating apparatus includes a temperature sensor that detects a temperature of the working fluid after the heat exchange with the coolant in the heat exchanger or a temperature of the coolant before the heat exchange with the working fluid in the heat exchanger, and
the control apparatus changes the ratio by controlling the flow distributor in accordance with the temperature detected by the temperature sensor.

10. The gas turbine system according to claim 1, further comprising:
a first flow path, a second flow path, and a third flow path, for the working fluid to flow, wherein:
in the first flow path, the first compressor and the combustor are present in this order,
in the second flow path, the first compressor, the inlet, the first outlet, the second compressor, the first cooler, and the second expansion turbine are present in this order,
in the third flow path, the first compressor, the inlet, the second outlet, the first cooler, and the second expansion turbine are present in this order, and
the third flow path bypasses the second compressor.
